(19) United States
(12) Patent Application Publication
(10) Pub. No.: US 2025/0070508 A1
(43) Pub. Date: Feb. 27, 2025

(54) DOORS FOR HOME APPLIANCE AND HOME APPLIANCE INCLUDING THE SAME

(71) Applicant: LG ELECTRONICS INC., Seoul (KR)

(72) Inventor: DongWoo KIM, Seoul (KR)

(21) Appl. No.: 18/816,285

(22) Filed: Aug. 27, 2024

(30) Foreign Application Priority Data
Aug. 29, 2023 (KR) 10-2023-0113777

(51) Int. Cl. H01R 13/631; F24C 15/02

(52) U.S. Cl. CPC H01R 13/6315; F24C 15/023

(57) ABSTRACT

A door for a home appliance includes a door body that is disposed in front of a storage space of the home appliance and accommodates an electronic component therein. A connector module is disposed in the door body. The connector module includes a mounting base disposed in the door body and a movement supporter fixing a door connector. The movement supporter linearly moves between a storage position and an operation position along the mounting base. The movement supporter is relatively turned to the mounting base at the operation position. When the door connector is turned, the door connector is exposed outward. When the door connector is turned, an assembly surface thereof at which assembling with a relative connector is performed faces the front side of the door, so assembly/separation of the connectors is easily performed.

### CROSS REFERENCE TO RELATED APPLICATIONS

The present application claims priority to and the benefit of Korean Patent Application No. 10-2023-0113777, filed on Aug. 29, 2023, the disclosure of which is incorporated herein by reference in its entirety.

### TECHNICAL FIELD

The present disclosure relates to a door for a home appliance.

### BACKGROUND

Home appliances may store target objects and include doors. For example, home appliances include a cooking appliance, a refrigerator, a clothing treating apparatus, etc. The home appliances may include storage spaces for storing target objects in cabinets, creating the external appearance thereof, and doors to open and close the storage spaces.

Various electronic components may be installed in the door of the home appliance. For example, a touch sensor device, a display device, etc. may be installed in the door.

The electronic components may be electrically connected to a main controller provided in a main body of the home appliance with one or more wires.

To facilitate the connection of the wire, the wire may be connected to a connector. For example, a door connector protruding from the door and a main body connector protruding from the main body of the home appliance may be assembled with each other. As described above, the door connector and the main body connector (which is also referred to as “connector assembly” in this disclosure) are disposed not to be exposed outward. For example, the connector assembly is stored in a frame of the main body close to the door and a storage entrance may be covered with a separate cover.

For instance, assembling of the connector assembly may be performed after the door is assembled to the main body. After the door is assembled to the main body, the door connector may be assembled to the main body connector. However, a narrow gap between the door and the main body may make the assembly of the connectors difficult.

Furthermore, to reduce exposure of the wire and the connector assembly, the connector assembly and the wire may be disposed at a lower portion of the main body. In this case, the assembly operation of the connector assembly may be performed at lower portions of the main body and the door. Accordingly, an operator (e.g., assembler) must put together the connector assembly without accurately checking the connector assembly with the naked eye, which requires skill in the assembly operation of the connector assembly and reduces the workability.

Specifically, a connector has directionality, and the operator must perform the assembly operation in the narrow space between the main body and the door while checking the direction of the connector assembly, which further reduces workability.

In some examples, regarding the home appliance, products such as cooking appliance that create high-temperature environments in a storage space cause the main bodies to be heated to high temperatures. As described above, the high temperature of the main body affects the connector assembly, reducing durability of the connector assembly and resulting in damage to the connector assembly.

In addition, due to the narrow inner space of the frame of the main body adjacent to the door, maintenance of the connector assembly is difficult. Specifically, to insert the connector assembly into the frame, or to remove the connector assembly inside the frame outward, the operator must access the connector assembly through the narrow inner space of the frame, which reduces workability. Furthermore, when the operator inserts the connector assembly deep inside the frame, it may be difficult to remove the connector assembly.

In some examples, the conventional connector assembly may not be guided along a specific path and may be installed to move freely when pulled by the connected wire. Accordingly, in such cases, the operator must precisely grip and fix the two connectors with both hands before assembling the connectors. However, as described above, when the two connectors are assembled in a narrow space, it may be difficult to grip and assemble the connectors, which may be a disadvantage.

In addition, a wire installed in the main body of the home appliance and a wire installed in the door may be fixed by separate fasteners at regular intervals for assembly stability. As described above, the connectors provided at terminal ends of the wires fixed by the fasteners are limited in terms of movable distances and directions. When the wires are sufficiently long, the operational distance for coupling the connectors increases, which improves workability. However, long exposed sections of wires that extend outward deteriorate the aesthetics and reduces the durability, as the sheath may be damaged due to friction with the external part. On the other hand, when the wires are shortened, the sections where the wires are exposed outward are shortened, improving the aesthetics and reducing friction with the external part. However, there creates some issues as the workability of assembling the two connectors is reduced.

### SUMMARY

The present disclosure describes assembling of a wire and a connector connected to an electronic component disposed in a door with a relative connector (main body connector) and storing the assembly in the door.

The present disclosure further describes moving a connector stored in a door between a storage position and an operation position along a constant path.

The present disclosure further describes exposing a connector moved to an operation position outward.

The present disclosure further describes aligning a connector in a constant direction when the connector is moved to an operation position.

The present disclosure further describes adjusting the storage depth of a connector in a door to respond to a variety of extra lengths of a wire.

Aspects of the present disclosure are not limited to the above-described ones.

Additionally, other aspects and advantages that have not been mentioned can be clearly understood from the following description and can be more clearly understood from implementations. Further, it will be understood that the aspects and advantages of the present disclosure can be realized via means and combinations thereof that are described in the appended claims.

According to the features of the present disclosure to achieve the above-described objectives, each of Door for a home appliance of the present disclosure may include a door body disposed in front of a storage space of the home appliance, and in which an electronic component is disposed. A connector module may be disposed in the door body. The connector module may include a mounting base disposed in the door body and a movement supporter fixing the door connector. Herein, the movement supporter may be linearly moved between a storage position and an operation position along the mounting base. The movement supporter may be relatively turned to the mounting base at the operation position. When the door connector is turned, the door connector may be exposed outward. As described above, when the door connector is turned, an assembly surface with the relative connector faces the front side of the door, so that assembly/separation of the connectors may be easily performed.

In addition, the mounting base may include a guide slot in a movement direction of the movement supporter. The movement supporter may include a supporter shaft inserted in the guide slot. The door connector may be moved in a constant path along the guide slot.

Furthermore, the mounting base may include a fixation rail in a direction parallel to the guide slot. A storage fixation part may be provided on the fixation rail and a surface of the movement supporter facing the fixation rail to restrict movement of the movement supporter.

Furthermore, the mounting base may include a mounting station at which the movement supporter is moved. The guide slot may be provided at a portion where the mounting station and the fixation rail are spaced apart from each other.

Furthermore, the guide slot may further protrude from one end of the mounting station outside of the mounting station, and the operation position may be provided at a portion where the guide slot further protrudes outside of the mounting station.

Furthermore, the guide slot may be provided at either side of the mounting base, and the supporter shaft may be provided on either surface of the movement supporter.

Furthermore, the storage fixation part may include a first position fixation part provided at the fixation rail and a second position fixation part engaged with the first position fixation part.

Furthermore, the first position fixation part may have an uneven structure sequentially disposed along a movement direction of the movement supporter. The second position fixation part may be caught and fixed by the first position fixation part due to elastic deformation.

Furthermore, the guide slot may be provided along the movement direction of the movement supporter to be relatively longer than the first position fixation part.

Furthermore, a turning part may be provided at a terminal end of the guide slot and allows the movement supporter to turn. The turning part may have a curved structure corresponding to a surface of the supporter shaft.

Furthermore, the supporter shaft may be provided eccentrically from a center of gravity of the movement supporter and the door connector.

In addition, a center of gravity of the movement supporter and the door connector may be provided at a location further farther from a front surface of the door body than the supporter shaft.

Furthermore, when the movement supporter is turned at the storage position, an assembly surface of the door connector may be exposed toward a front space of the door body.

In addition, a slot entrance may be provided at one end of the guide slot, and the supporter shaft of the movement supporter may be inserted into the guide slot through the slot entrance.

Furthermore, the slot entrance may be provided in a first direction. The guide slot may be provided in a second direction different from the first direction.

In addition, an insertion guide may protrude from the mounting base in the first direction, and the slot entrance may be provided at the insertion guide.

Furthermore, the insertion guide may include an insertion channel in the first direction, and the insertion channel may be connected to the slot entrance.

In addition, a supporter foot may protrude on a surface of the movement supporter, and when the movement supporter is moved along the mounting base, the supporter foot may be brought into close contact with a surface of the mounting base.

Furthermore, the movement supporter may be disposed at the mounting base in the first direction. The movement supporter may be linearly moved in the second direction along the mounting base. The movement supporter may be relatively turned to the mounting base in the third direction.

As described above, the doors of a home appliance and the home appliance including the same according to the present disclosure have the following effects.

In the present disclosure, the door connector connected to the electronic component in the door, and the relative connector (main body connector or external connector) assembled with the door connector may be stored in the door. Accordingly, since the connectors do not need to be stored in a narrow space provided at a side surface or a lower portion of the main body of the home appliance, the storage performance of the connectors can be improved.

In the present disclosure, the connectors are stored in the door, not the main body of the home appliance. Accordingly, the connectors can be less affected by harsh environments of the main body in which the temperature and the humidity are excessively high or low. Accordingly, the durability of the connectors can be improved, and the operation reliability of the connectors can be improved.

In addition, in the present disclosure, the door connector may be moved in a constant path along the mounting base disposed in the door. The door connector and the relative connector assembled to each other are disposed on a preset regular path, so the fabricator can easily predict the storage position of the connectors. Accordingly, the maintainability of the connectors can also be improved.

Furthermore, since the door connector and the relative connector assembled to each other are stored/discharged along the constant regular path, it is possible to prevent the connectors from deviating from the preset movement path and covering the window disposed at the central portion of the door. Accordingly, the aesthetic feeling of the door and the home appliance can also be improved.

Specifically, in the present disclosure, the door connector and the relative connector may be disposed in the edge portion (installation region) provided around the window of the door. Therefore, the door connector and the relative connector can be covered by the edge portion when being located in the storage position, so it is possible to prevent outward exposure of the door connector and the relative connector.

In addition, when the door connector is moved along the connector storage part to the operation position, the door connector may be exposed outside the door. The fabricator can assemble or separate the outward exposed door connector to/from the relative connector, so assembly/separation of the connectors can be easily performed.

Specifically, in the present disclosure, when the door connector is turned, the assembly surface with the relative connector faces the front side of the door. Therefore, the fabricator does not need to check the directionality of the door connector, so high skill in the assembly operation of the connectors is not required and the workability can be improved.

Furthermore, in the present disclosure, the center of gravity of the door connector and the movement supporter is eccentric from the turning shaft, so that the door connector and the movement supporter moved to the operation position may be automatically turned by gravity. Therefore, even though the fabricator does not turn the door connector, the assembly surface of the door connector faces the front side of the door, and assembly/separation of the connectors can be easily performed.

In addition, in the present disclosure, the door connector and the relative connector coupled thereto may be fixed to various positions by the storage fixation part provided along the connector storage part. Accordingly, the mounting depth of the door connector and the relative connector can be varied, and a variety of extra lengths of the wires connected to the connectors can be accommodated. Therefore, the assembly compatibility of the connectors can be improved.

Furthermore, in the present disclosure, the door connector is mounted to the movement supporter first and then is moved with the movement supporter along the mounting base. The structure to move the door connector should be provided in the movement supporter and the mounting base, so the existing door connector can be used. Therefore, the present disclosure has the effect of high compatibility of the connector.

Furthermore, in the present disclosure, the mounting base includes the guide rail, and the movement range of the door connector can be limited. Accordingly, the door connector and the relative connector can be prevented from being moved and inserted too deeply into the door.

### BRIEF DESCRIPTION OF THE DRAWINGS

FIG. 1 is a perspective view illustrating an embodiment of a home appliance according to the present disclosure.

FIG. 2 is a perspective view illustrating the embodiment of the present disclosure with a separated side cover constituting the embodiment.

FIG. 3 is a perspective view illustrating a lower door constituting the embodiment of the present disclosure.

FIG. 4 is an exploded perspective view illustrating main components of the lower door constituting the embodiment of the present disclosure.

FIG. 5 is a perspective view, in greater detail than FIG. 4, illustrating the main components of the lower door constituting the embodiment of the present disclosure.

FIG. 6 is a perspective view illustrating a structure of the lower door, an image acquisition module, a connector module, a main wire, and a connector wire constituting the embodiment of the present disclosure.

FIG. 7 is a perspective view illustrating the internal part of the lower door without a rear frame and an inner frame of the lower door constituting the embodiment of the present disclosure.

FIG. 8 is a sectional view illustrating the internal structure of the lower door constituting the embodiment of the present disclosure.

FIG. 9 is a perspective view illustrating an embodiment of the connector module constituting the door for a home appliance according to the present disclosure.

FIG. 10 is a perspective view illustrating the embodiment of the connector module in FIG. 9, which is taken at a different angle from FIG. 9.

FIG. 11 is an exploded perspective view illustrating parts of the embodiment of the connector module constituting the present disclosure.

FIG. 12 is a perspective view illustrating a door connector that is assembled to a movement supporter in the embodiment of the connector module constituting the present disclosure.

FIG. 13 is a side view illustrating the door connector assembled to the movement supporter constituting the embodiment of the connector module according to the present disclosure.

FIGS. 14 to 17 are operational state views sequentially illustrating a process in which the connector module of the embodiment constituting the present disclosure is moved from a storage position to an operation position and then coupled to a main connector.

FIG. 18 is a perspective view illustrating the connector module disposed at the storage position with the lower door, in the embodiment of the connector module constituting the present disclosure.

FIG. 19 is a perspective view illustrating the connector module disposed at the operation position with the lower door, in the embodiment of the connector module constituting the present disclosure.

FIG. 20 is a perspective view illustrating another embodiment of the home appliance according to the present disclosure.

### DETAILED DESCRIPTION

The present disclosure relates to one or more Door for an appliance, e.g., a home appliance. For example, the home appliance can include a storage space therein. The door can open and close the storage space. The door can be applied to various home appliances such as a cooking appliance, a refrigerator, a freezer, a kimchi refrigerator, a plant cultivating apparatus, Styler®, a washing machine, etc. In some examples, the door can be applied to a door of furniture or an entrance door. In some implementations, the door includes two doors 50 and 70, but the door of the present disclosure can also be applied to a home appliance equipped with a single lower door 70. Hereinafter, the present disclosure will describe an example in which two doors 50 and 70 are applied to a cooking appliance. Furthermore, a door at a relatively upper side of the two doors 50 and 70 can be called an upper door 50, and a door at a lower side can be called a lower door 70.

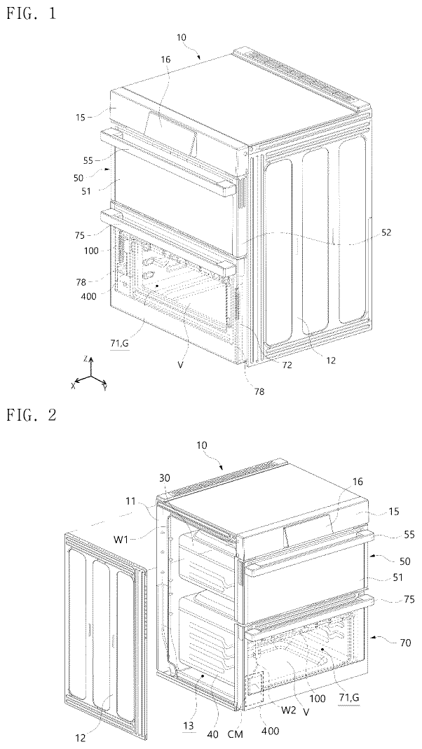

Herein, the front side may be a direction toward a user when the user is located in front of the home appliance. Referring to FIG. 1, an X-axial direction may be a forward direction. A Y-axial direction may be a width direction of a door 50, 70. A Z-axial direction may be a height direction of the door 50, 70. Hereinbelow, the present disclosure will be described based on the directions.

In some implementations, an electronic component can be disposed in the lower door 70 of the doors 50, 70. The electronic component can provide various functions to the lower door 70. For example, when the electronic component is an image acquisition module 100, the image acquisition module 100 can be used to obtain an inside image through a storage space. The lower door 70 can include the inner illuminance of the storage space. In some examples, the image acquisition module 100 can include an image sensing device 170 and a lighting device 180.

In some implementations, a display device can be disposed at the lower door 70 as an electronic component. The display device can provide the information of the home appliance to a user. The user can input an operational command through the display device.

The image acquisition module 100 or a part of the display device can be provided in the lower door 70. At this point, the electronic component such as the image acquisition module 100, the display device, or the like can receive and transmit an electric signal with a main controller provided in a main body of the home appliance, or can be connected to the main body with a wire to supply power.

At this point, a connector 470, 490 can be connected to the wire. The connector 470, 490 can include a door connector 470 disposed in the lower door 70 and a main connector disposed in the main body. The door connector 470 can be assembled with the main connector to be electrically connected thereto. On the other hand, the door connector 470 may not be assembled with the main connector, but an external connection connector. Herein, both the main connector and the connection connector will be called a relative connector 490.

Hereinbelow, it will be described that the electronic component disposed in the lower door 70 is the image acquisition module 100 as an example.

Referring to FIG. 1, the view illustrates a cooking appliance equipped with the doors 50 and 70. A main body 10 of the cooking appliance can be roughly shaped into a hexahedral form. In some examples, the main body 10 of the cooking appliance can include two doors 50 and 70. The two doors 50 and 70 can be disposed at different heights. The two doors 50 and 70 can serve to respectively shield different storage spaces.

FIG. 2 illustrates a separated state of a side cover 12 constituting the main body 10 of the cooking appliance. When the side cover 12 is separated, an internal space 13 of the main body 10 of the cooking appliance can be exposed. Two cabinets 30 and 40 can be disposed inside the inside space 13 at different heights. The two cabinets 30 and 40 can include the storage spaces separated from each other. In some implementations, the inside space 13 can include one cabinet or three or more cabinets 30 and 40. In some implementations, the two cabinets 30 and 40 can be disposed transversely. Reference numeral 11 indicates a rear cover constituting the main body 10 of the cooking appliance.

An upper panel 15 can be provided at an upper portion of the cooking appliance. The upper panel 15 can be disposed on an upper end portion of a front surface of the cooking appliance. The upper panel 15 can include an operating part 16. The operating part 16 can be used to operate functions of the cooking appliance and display a state of the cooking appliance. The operating part 16 can be composed of a display capable of being operated in a touch manner. In some implementations, the operating part 16 can include a knob rotatably moved. In some implementations, the operating part 16 can be omitted, and the display device can be disposed at the lower door 70.

The upper panel 15 can be connected to a main wire W1. The main wire W1 can connect the operating part 16 and a main controller to each other. In some examples, the main wire W1 can connect the operating part 16 to the electronic component of the lower door 70, such as the image acquisition module 100. The main wire W1 can be connected to a connection wire W2 described below, through a door wire W2.

The two cabinets 30 and 40 can be classified into a first cabinet 30 and a second cabinet 40. The first cabinet 30 and the second cabinet 40 can be disposed in the inside space 13 at different heights. An upper storage space can be provided in a first cabinet 30. A lower storage space can be provided in the second cabinet 40. In some examples, the upper storage space and the lower storage space can be separated from each other, and can be open only at the front portions.

The upper door 50 can be disposed in front of the first cabinet 30. The lower door 70 can be disposed in front of the second cabinet 40. In some implementations, the upper door 50 and the lower door 70 can be operated in a kind of pull-down method in which each upper end is vertically swung on a lower end thereof. In some implementations, the upper door 50 and the lower door 70 can be operated in a side swing method in which each door is opened sideways.

In the upper door 50, a front surface 51 of the upper door 50 can have a structure allowing the upper storage space to be visible. For example, the front surface 51 of the upper door 50 has a glass panel structure, and a user can observe the inside part of the upper storage space through the upper door 50. In some examples, the front surface 51 of the upper door 50 can be made of dark materials or be coated with a separate film, thereby preventing the upper storage space from being visible from the outside. Reference numeral 55 indicates a first handle to open and close the upper door 50.

The lower door 70 can be disposed below the upper door 50. The lower door 70 can be disposed in front of the second cabinet 40. The lower storage space can be visible through a front surface of the lower door 70. The user can observe the inside of the lower storage space through the front surface of the lower door 70.

In some implementations, the lower door 70 can include a window V. The window V allows the lower storage space to be visible from the outside space and can be made of a transparent material. The window V can be understood as a part of a front panel Ga constituting the front surface of the lower door 70. The window V can be provided in a central portion of the front panel Ga. For example, an edge portion of the front panel Ga can have a material with higher surface roughness unlike the window V Otherwise, a separate opaque film can be applied to the edge portion of the front panel Ga. Then, excluding the window V, the edge portion of the front panel Ga prevents the lower storage space form being visible.

In some implementations, the edge of the front panel Ga corresponding to the outside part of the window V can be covered by a door frame 72, 77, 80, 90. Herein, the outside part of the window V can be the edge portion of the front panel Ga that surrounds the edges of the window V with the window V as the center.

In some implementations, the lower door 70 can be made of dark materials or coated with a separate film, thereby preventing the lower storage space from being visible from the outside space. In some implementations, in the lower door 70, the door panel G which will be described below can be omitted, and an opaque metallic or nonmetallic plate can define the front surface thereof. Also, in this case, the lower storage space may not be visible from the outside space.

FIG. 2 illustrates the image acquisition module 100 and the connector module 400 which are mounted inside the lower door 70. Although FIG. 2 illustrates the image acquisition module 100 and the connector module 400 indicating positions where the image acquisition module 100 and the connector module 400 are mounted inside the lower door 70, the image acquisition module 100 and the connector module 400 may not be visible from the front space of the cooking appliance. This is because, as described above, the edge portion of the front panel Ga excluding the window V is opaque. Reference numeral 75 indicates a second handle to open and close the lower door 70.

In some examples, the image acquisition module 100 can be disposed in the upper door 50. In some examples, two image acquisition modules 100 can be disposed in the upper door 50 and the lower door 70 respectively. In some examples, the image acquisition module 100 and the connector module 400 can be separately disposed in the upper door 50 and the lower door 70.

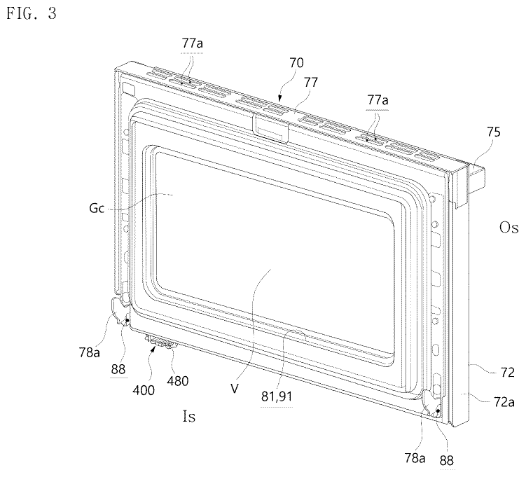

FIG. 3 illustrates the lower door 70 when viewed from the rear side. The front surface of the lower door 70 can have a flat surface structure. In some examples, the surface of the front panel Ga can define the front surface of the lower door 70.

The window V can be provided in the central portion of the front surface of the lower door 70. The window V can be a portion made of a transparent or translucent material so that the lower storage space can be visible from the outside space. The window V can be located through a central portion of a plurality of panels constituting the door panel G. FIG. 3 illustrates the window V provided in a central portion of a second rear panel Gc constituting the door panel G.

A frame of the lower door 70 can be formed from the door body. The door body can include the door frame 72, 77, 80, 90 and the door panel G. The door body can have roughly a hexahedral structure when the door frame 72, 77, 80, 90 and the door panel G are assembled.

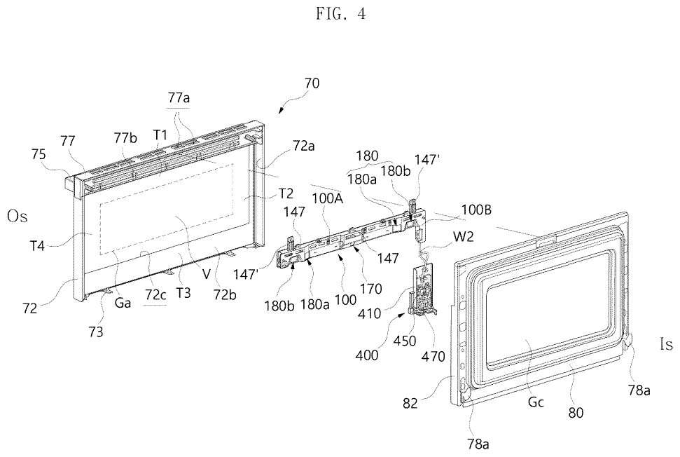

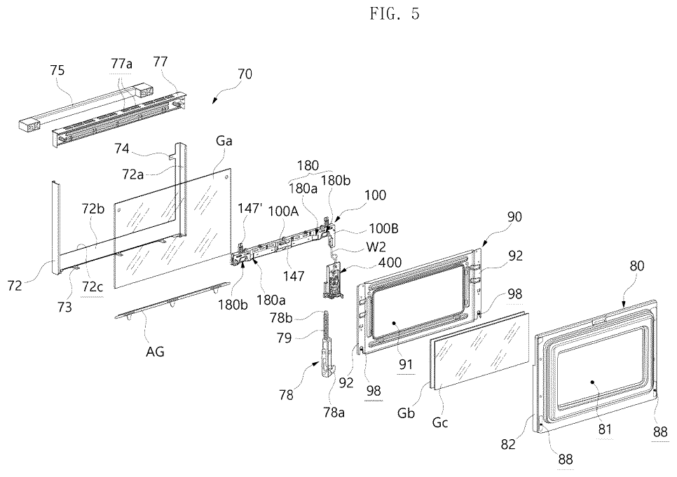

Referring to FIGS. 4 and 5, the door frame 72, 77, 80, 90 can include multiple frame parts. In some implementations, the door frame 72, 77, 80, 90 can include a front frame part 72, a rear frame part 80, an inner frame part 90, and the upper frame part 77. The frame parts can be coupled to each other to provide one door frame 72, 77, 80, 90.

Herein, “front” is based on the front side of the lower door 70. For reference, in the entire drawings including FIG. 4, “Is” indicates the inside area of the lower door 70 facing the storage space, and “Os” indicates the outside area of the home appliance, i.e., the outside space of the lower door 70.

The front frame part 72 can be disposed at the front part of the door frame 72, 77, 80, 90. More specifically, the front frame part 72 can form a front frame of the door frame 72, 77, 80, 90. The front frame part 72 can be formed roughly in a rectangular frame shape. The front frame part 72 can be formed in a rectangular frame shape with an upper portion and a lower portion open upward and downward, respectively. A pair of front side plates 72a can be provided at both sides of the front frame part 72. The pair of front side plates 72a can stand vertically. A front lower plate 72b can connect the pair of front side plates 72a to each other while being located therebetween. The front side plates 72a and the front lower plate 72b are connected to each other to form roughly a “U” shape.

A front opening 72c can be provided between the front side plates 72a and the front lower plate 72b. The front opening 72c can bean empty space open in a longitudinal direction. The front panel Ga constituting the door panel G (referring to FIG. 1) can be disposed in the front opening 72c. It can be understood that an open portion of the front opening 72c is filled with the front panel Ga.

More specifically, the region of the door panel G is wider than the region of the front opening 72c, so a part of the front side plates 72a and a part of the front lower plate 72b can be stacked with the door panel G respectively. The front side plates 72a, the front lower plate 72b, and the front panel Ga can be coupled to each other by an adhesive or an adhesive tape. FIG. 4 illustrates the front panel Ga and the front frame part 72 stacked to each other. FIG. 4 illustrates the front panel Ga with a lower portion covering most of a rear surface of the front lower plate 72b.

With the second front side plates 72a of the front frame part 72 located in the center, the front panel Ga can be disposed at one side. The second handle 75 can be disposed at the opposite side of the second front side plates 72a. Herein, a separate fastener can pass through the second front side plates 72a and a panel fastening hole G2a′ of the front panel Ga and then can be fastened to a handle assembly part 75a of the second handle 75.

A lower frame part 73 can be provided at a lower end of the front frame part 72. The lower frame part 73 can be a part of the front frame part 72 or a separate object. The lower frame part 73 can have a shape bent from the lower end of the front frame part 72. The lower frame part 73 can include a connector inlet 73a. The connector inlet 73a can be provided at an operation position described below. An operator can access a connector storage portion CM through the connector inlet 73a.

The image acquisition module 100 can be disposed in rear of the front panel Ga. Herein, the image acquisition module 100 can be adhered to a rear surface of the front panel Ga. More specifically, a partial surface of a front surface of the image acquisition module 100 and a partial surface of the rear surface of the front panel Ga can be adhered to each other.

For reference, the image acquisition module 100 can include an image sensing device 170. The image acquisition module 100 can include a plurality of lighting devices 180 with the image sensing device 170. The plurality of lighting devices 180 increases the illuminance of the lower storage space so that the image sensing device 170 acquires a clearer image. In some examples, the plurality of lighting devices 180 can include a first lighting part 180a and a second lighting part 180b. In some examples, the image sensing device 170 or the plurality of lighting devices 180 can be omitted.

Referring to FIG. 5, a rear panel Gc of insulation panels Gb and Gc constituting a rear surface of the lower door 70 can be exposed rearward. The rear panel Gc can also include a window V. The window V of the rear panel Gc and the window V of the front panel Ga can be successively disposed at a predetermined distance therebetween and assigned with the same reference numeral. Although no reference numeral is assigned, in the insulation panels Gb and Gc, the inner panel Gb unexposed outward of the lower door 70 can also have a window V.

Referring to FIG. 5, a rear panel Gc of insulation panels Gb and Gc constituting a rear surface of the lower door 70 may be exposed rearward. The rear panel Gc may also include a window V. The window V of the rear panel Gc and the window V of the front panel Ga are successively disposed at a predetermined distance therebetween and assigned with the same reference numeral. Although no reference numeral is assigned, in the insulation panels Gb and Gc, the inner panel Gb unexposed outward of the lower door 70 may also have a window V.

The inner panel Gb and the rear panel Gc can define the insulation panels Gb and Gc. The inner panel Gb and the rear panel Gc can be stacked to each other at a constant distance. In addition, an empty space between the inner panel Gb and the rear panel Gc can become a vacuum, thereby increasing insulation performance. In some implementations, the insulation panels Gb and Gc can include only the rear panel Gc without the inner panel Gb.

Installation regions T1 to T4 can be provided between the front panel Ga and the insulation panels Gb and Gc. The installation regions T1 to T4 can be provided in the empty space between the front panel Ga and the insulation panels Gb and Gc. The installation regions T1 to T4 can be a portion where the image acquisition module 100 and the connector module 400 are disposed. In some implementations, the insulation panels Gb and Gc are omitted, and the installation regions T1 to T4 can be disposed between the front panel Ga and the door frame 72, 77, 80, 90.

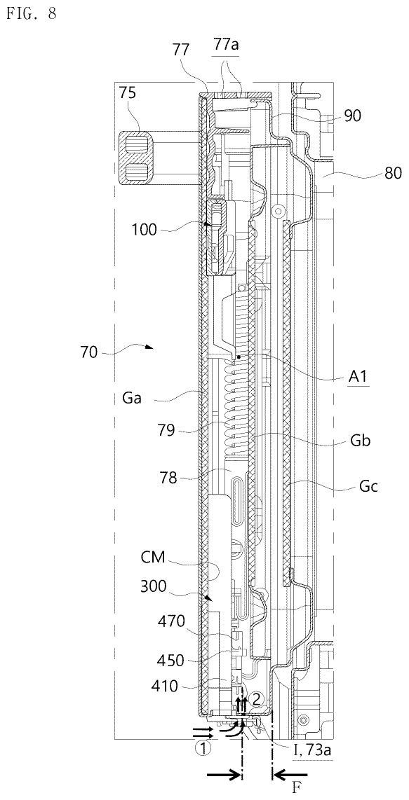

Referring to FIG. 8, a cooling flow path A1 may be provided between the front panel Ga and the insulation panels Gb and Gc. The cooling flow path A1 may be the entire space between the front panel Ga and the insulation panels Gb and Gc. The installation regions T1 to T4 may be disposed outside the window V with the window V as the center. Therefore, the cooling flow path A1 is wider than the installation regions T1 to T4, and the installation regions T1 to T4 may constitute a part of the cooling flow path A1.

Air can flow into the door panel G along the cooling flow path A1. Accordingly, the cooling flow path A1 can be a flowing space in which air flows.

In some implementations, the door panel G may not be provided as a separate object, but can be apart of the doorframe 72, 77, 80, 90. The door panel G can be integrally provided with the door frame 72, 77, 80, 90. In this case, the door panel G may not be made of a transparent material and can shield the lower storage space to prevent the lower storage space from being exposed. The door panel G can be made of the same material as the door body. For example, the door panel G can have a metal or nonmetal plate structure.

In FIG. 4, the installation regions T1 to T4 are indicated. The installation regions T1 to T4 are portions where the image acquisition module 100 and the connector module 400 are disposed, and a dotted line in FIG. 4 is expressed to help understand the installation regions T1 to T4. In FIG. 4, the installation regions T1 to T4 are illustrated at the rear surface of the front panel Ga, but the installation regions T1 to T4 are actually provided in the empty space between the plurality panels and the door frame 72, 77, 80, 90.

Herein, the upper frame part 77 of the door frame 72, 77, 80, 90 can cover a part of an upper end of the rear surface of the front panel Ga. Apart of the installation regions T1 to T4 can be formed in a portion not covered by the upper frame part 77. More specifically, in the installation regions T1 to T4, the first installation region T1, T3 can be provided at a lower portion of the upper frame part 77 that is not covered by the upper frame part 77.

The installation regions T1 to T4 can include (i) the first installation region T1, T3 formed in a first direction along an edge of the window V, and (ii) a second installation region T2, T4 formed in a second direction different from the first direction along an edge of the window V. In some examples, the first direction is a transverse direction (a transverse width direction of the lower door 70), and the second direction is a vertical direction (a height direction of the lower door 70). In the embodiment, the first direction is a transverse direction (Y-axial direction in FIG. 1), and the second direction is a vertical direction (Z-axial direction in FIG. 1).

The first installation region T1, T3 can be formed at each of an upper portion T1 and a lower portion T3 of the window V with the window V as the center. The second installation region T2, T4 can be formed at each side portion of the window V with the window V as the center. In other divisions, the installation region T1 to T4 can be divided into (i) the upper region T1 provided at the upper portion of the window V, (ii) the right region T2 provided at the right portion of the window V, (iii) the lower region T3 provided at the lower portion of the window V, and (iv) the left region T4 provided at the left portion of the window V. The division is based on FIG. 4.

The first installation region T1, T3 and the second installation region T2, T4 can be connected to each other. Opposite end portions of the first installation region T1, T3 and the opposite end portions of the second installation region T2, T4 are connected to each other. Accordingly, the installation regions T1 to T4 can be formed in connected spaces. Then, the image acquisition module 100 and the connector module 400 can be disposed to pass through the multiple installation regions T1 to T4.

In some examples, a main unit 100A, i.e., a part of the image acquisition module 100 can be disposed in the first installation region T1, T4. Apart of a connection unit 100B, i.e., a remaining part of the image acquisition module 100 can be disposed in the second installation region T2, T4. The image acquisition module 100 and the connector module 400 can be electrically connected to each other through the door wire W2. In some implementations, the connector module 400 is disposed in the second installation region T2, T4.

At least a part of the installation regions T1 to T4 can be provided at a region where a part of the door frame 72, 77, 80, 90 covers a rear surface of the front panel Ga. At this point, covering, by the rear frame part 80, a part of the image acquisition module 100 can be based on the rear space of the lower door 70, i.e., a direction from the inside space of the lower storage space to the rear surface of the lower door 70 when the lower door 70 is closed.

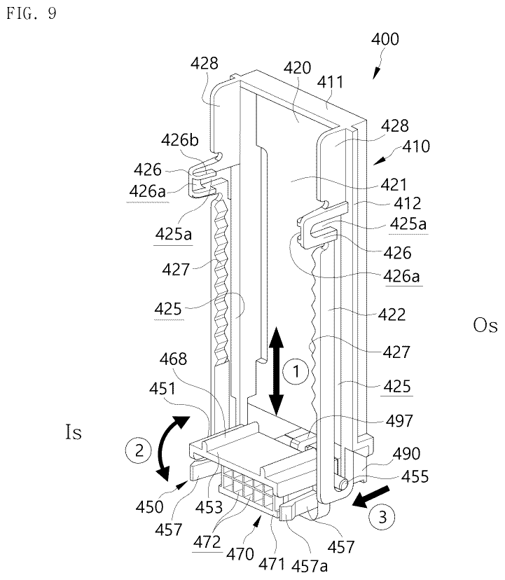

In some implementations, the connector module 400 can be disposed in a part of the second installation region T2, T4, and a part of the first installation region T1, T3. FIG. 9 illustrates the connector module 400 disposed over the right side region T2 provided at the right side portion of the window V, and the lower region T3 provided at a lower portion of the window V Both the right side region T2 and the lower region T3 are provided outside the window V, so the regions may not be exposed outward.

In some implementations, the connector module 400 can be disposed at one of the regions including the upper region T1, the lower region T3, and the left side region T4. In some examples, the connector module 400 does not extend to the lower region T3, and can be disposed in the right side region T2.

Preferably, considering the accessibility of the operator, one end portion of the connector module 400 can be disposed at an outer edge of the installation region T1 to T4. Then, the operator can easily access one end portion of the connector module 400 to assemble or maintain the connector module 400.

The image acquisition module 100 can be disposed in the first installation region T1, T3, and the door wire W2 for allowing signal transmission and power supply between the image acquisition module 100 and the main controller can be disposed in the second installation region T2, T4.

Herein, the front panel Ga may be divided into the window V, and an edge part disposed around the edges of the window V. Herein, the installation regions T1 to T4 may be provided on a rear surface of the edge part. At this point, the edge part may be processed to be opaque. Accordingly, the installation regions T1 to T4 provided at a lower surface of the edge part may not be exposed from the front space of the lower door 70, i.e., from the front space of the cooking appliance. The edge part may be formed by etching a part of the front panel Ga to increase the surface roughness, or by being coated with a separate film, or by being treated opaquely by a painting process.

In some implementations, the upper frame part 77 can be disposed above an upper portion of the front opening 72c. The upper frame part 77 can be coupled to an upper portion of the front frame part 72, more specifically, to the upper ends of the pair of front side plates 72a. The upper frame part 77 can cover a part of an upper end of the rear surface of the front panel Ga. The image acquisition module 100 described below can be fixed to the upper frame part 77. Reference numerals 147 and 147′ indicate module fastening parts to which fasteners are coupled to fix the image acquisition module 100 to the upper frame part 77.

The frame outlet 77a can be open in the upper frame part 77. The frame outlet 77a can be an outlet through which air passing through the cooling flow path A1 formed in the lower door 70 is discharged outward. The frame outlet 77a can be connected to the installation regions T1 to T4 as described below.

Referring to FIG. 5, the lower door 70 can include a door hinge 78. The door hinge 78 can allow the lower door 70 to be connected to the main body 10 of the cooking appliance to be turned. The door hinge 78 can be disposed in the lower door 70, more specifically, in an empty space formed between the front frame part 72 and an inner frame part 90. A door hinge arm 78a can protrude on the door hinge 78. The hinge holding arm 78a can pass through an inner hinge passage part 98 of the inner frame part 90 and a rear hinge passage part 88 of the rear frame part 80 in order, and then can be fixed by being caught by the main body 10 of the cooking appliance. Reference numeral 79 is a hinge spring 79 and can be fitted over a spring guide 78b of the door hinge 78. The hinge spring 79 can provide an elastic force to the door hinge 78 in a direction of closing the lower door 70 while being tensioned when the lower door 70 is opened.

With the door panel G located in the middle, the front frame part 72 can be disposed at the front of the door panel G, and the inner frame part 90 and the rear frame part 80 can be disposed at the rear of the door panel G. The inner frame part 90 and the rear frame part 80 are spaced apart from each other (i) to form an insulation space therebetween, and (ii) to fix the second insulation panels Gb and Gc. The inner frame part 90 can be disposed between the rear frame part 80 and the front frame part 72, thereby being unexposed outward.

The rear frame part 80 can be roughly formed in a rectangular frame shape. When the lower door 70 is closed, the rear frame part 80 can face a front surface of the second cavity. The rear through part 81 can be open on a central portion of the rear frame part 80. The rear through part 81 can have a longitudinally open structure so that the internal space of the lower storage space can be visible through the window V.

Rear side plates 82 can be provided at side surfaces of the rear frame part 80. The rear side plates 82 can be bent forward of the lower door 70. The rear side plates 82 can be disposed inside the front side plates 72a. Reference numeral 88 is the rear hinge passage part 88 through which the door hinge arm 78a of the door hinge 78 passes.

The rear frame part 80 can cover a part of the connector module 400. Accordingly, even when the user opens the lower door 70, the connector module 400 may not be exposed through the window V.

The inner frame part 90 can be coupled to the rear frame part 80. The inner frame part 90 can be formed roughly in a rectangular frame shape. When the lower door 70 is closed, the inner frame part 90 can stand vertically at a distance from the rear frame part 80. An inner through part 91 can be open on a central portion of the inner frame part 90. The inner through part 91 can have a longitudinally open structure so that the internal space of the lower storage space can be visible through the window V.

Inner side plates 92 can be provided at side surfaces of the inner frame part 90. The inner side plates 92 can be bent forward of the lower door 70. The inner side plates 92 can overlap with the rear side plates 82. At the overlapped portions, the inner side plates 92 and the rear side plates 82 can be coupled to each other in a method such as welding, adhesion, or fastening by a separate fastener.

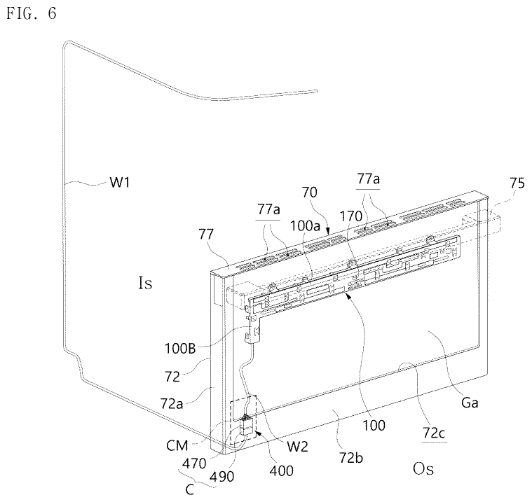

FIG. 6 illustrates the lower door 70 when viewed from the front space of the lower door 70. A wire to achieve power supply or signal transmission can be disposed in the main body 10 and the lower door 70 of the home appliance. The wire can include the main wire W1 to connect the connector module 400 of the lower door 70 to the main controller in the main body 10, and the door wire W2 to connect the connector module 400 to the image acquisition module 100.

When necessary, the operator can separate the main wire W1 from the connector module 400, and perform maintenance/repairing to the image acquisition module 100. For reference, FIG. 6 is a perspective view illustrating the image acquisition module 100. However, the image acquisition module 100 can be shielded by the edge part of the front panel Ga. FIG. 6 illustrates the door connector 470 constituting the connector module 400 assembled to the relative connector 490.

The connector module 400 can be disposed in the installation region T1 to T4 of the lower door 70. More specifically, the connector storage portion CM can be provided in the installation region T1 to T4. The connector module 400 can be disposed in the connector storage portion CM. The connector storage portion CM can be an empty space, i.e., a part of the installation region T1 to T4. In some implementations, the connector storage portion CM can be a kind of bracket integrated with the installation region T1 to T4, or provided as a separate object.

In FIG. 6, the connector storage portion CM can be disposed close to a lower end portion of a side surface of the lower door 70. When the connector storage portion CM is disposed at the lower end portion of the lower door 70, the operator can access the connector module 400 through the lower portion of the lower door 70. When the connector storage portion CM is disposed at the lower end portion of the lower door 70, the connector module 400 can be prevented from being exposed outward normally. Furthermore, as described below, the connector inlet 73a of the connector storage portion CM can open through the lower end portion of the lower door 70, so the operator can easily access the connector module 400.

In some implementations, the connector storage portion CM can be disposed close to an upper end portion of a side surface of the lower door 70. Furthermore, the connector inlet 73a of the connector storage portion CM can be open through the side surface of the lower door 70.

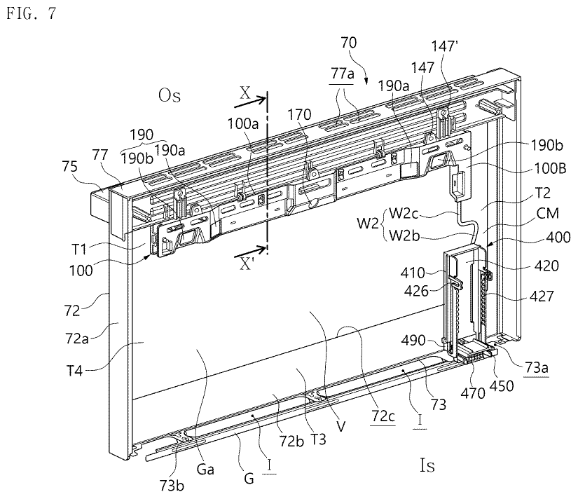

FIG. 7 illustrates the connector module 400 disposed in the connector storage portion CM. Herein, the view illustrates the relative connector 490 separated from the door connector 470 of the connector module 400. The door connector 470 can be disposed at a lower end portion of the connector storage portion CM. Accordingly, the relative connector 490 can be easily assembled to and separated from the door connector 470.

As illustrated in FIG. 7, the connector storage portion CM can be disposed outside the window V. Accordingly, the connector storage portion CM and the connector module 400 disposed in the connector storage portion CM may not be exposed outward, or the exposed region can be minimized.

In the embodiment, the door connector 470 of the connector module 400 may be moved between a storage position and an operation position. Herein, the storage position is a position where a connector assembly C is moved to the inside part of the connector storage part CM not to be exposed outward. The operation position is a position where the door connector 470 is moved to the connector inlet 73a of the connector storage part CM to be assembled to/separated from the relative connector 490 and an assembly surface 471a of the door connector 470 is exposed outward. Herein, the storage position may be a first position, and the operation position may be a second position.

The lower frame part 73 can be provided at the lower end of the lower door 70. The connector inlet 73a of the connector storage portion CM can be open in the lower frame part 73. As illustrated in FIG. 9, the connector inlet 73a can be formed by vertically penetrating the lower frame part 73. The connector inlet 73a can be a part of air inlets I, i.e., a plurality of inlets of the cooling flow path A1 which are open in the lower frame part 73. Reference numeral 73b indicates a bracket provided in the lower frame part 73 to mount the air guide G. Furthermore, reference numeral 190 is a lighting cover to cover each lighting device 180.

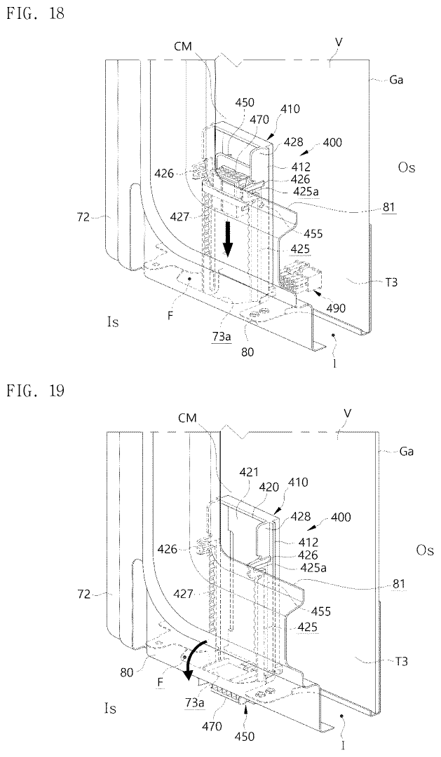

The connector module 400 can include the door connector 470. The door connector 470 can be connected to a first end portion of the door wire W2. The first end portion of the door wire W2 can be coupled to the door connector 470, and a second end portion can be connected to the image acquisition module 100. FIG. 19 illustrates the second end portion of the door wire W2 connected to an open connection hole 130a of the connection unit 100B of the image acquisition module 100.

The door connector 470 can be disposed in the connector storage portion CM. The door connector 470 can be moved between the first position and the second position in the connector storage portion CM. The first position can be the storage position. The second position can be the operation position. For reference, FIG. 9 illustrates the door connector 470 disposed at the storage position.

In some examples, the door connector 470 can be mounted to a movement supporter 450 and moved with the movement supporter 450. The movement supporter 450 can be mounted to the connector storage portion CM. Herein, the movement supporter 450 can be moved along a mounting base 410 disposed in the connector storage portion CM. In some examples, the movement supporter 450 can be omitted, and the door connector 470 can be directly disposed in the mounting base 410. The structures of the movement supporter 450 and the mounting base 410 will be described below.

FIG. 8 illustrates the connector storage portion CM provided at the lower portion of the lower door 70. The connector storage portion CM can be provided around a lower inlet of the cooling flow path A1. The door connector 470 can be disposed in the connector storage portion CM. To move the door connector 470, there is a need to access the connector storage portion CM. In some examples, the connector inlet 73a can be open in the lower portion of the lower door 70.

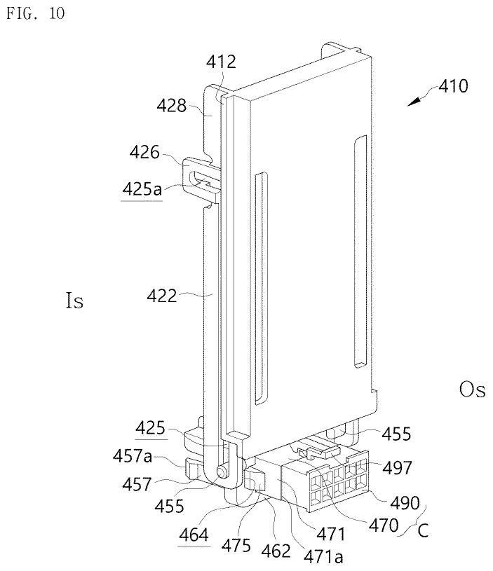

Herein, the width of the connector inlet 73a can be larger than the thickness of the door connector 470. Herein, the width of the connector inlet 73a can be based on the transverse direction of the lower door 70 and can be the transverse width based on FIG. 10. The thickness of the door connector 470 can be based on the longitudinal direction of the lower door 70. When the width of the connector inlet 73a is larger than the thickness of the door connector 470, the connector inlet 73a can have a clearance. The clearance can be an operation space F. FIG. 10 illustrates the width of the operation space F. The operator can access the door connector 470 through the operation space F.

The operation space F can be formed between a surface of the door connector 470 and an edge of the connector inlet 73a. The operation space F can be an empty space between the surface of the door connector 470 and the inner frame part 90. The operation space F can be a space through which the operator can access the door connector 470 and an air inlet through which external air is introduced into the lower door 70 at the same time.

FIG. 9 illustrates an example of the connector module 400. The connector module 400 can be disposed between the main wire W1 and the door wire W2. More specifically, the relative connector 490 to which the main wire W1 is connected can be connected to the door connector 470 to which the door wire W2 is connected, in the connector module 400. FIG. 11 illustrates the door wire W2 and the main wire W1 electrically connected to each other with the door connector 470 and the relative connector 490 assembled.

In FIG. 9, the connector module 400 may include the mounting base 410, the movement supporter 450, and the door connector 470. The mounting base 410 may be fixed to the door body. The movement supporter 450 and the door connector 470 may be relatively moved with respect to the door body. The movement supporter 450 and the door connector 470 may be moved between the storage position and the operation position along the mounting base 410 (a direction of arrow \textcircled{1}). In addition, in the embodiment, the door connector 470 disposed at the operation position may be configured such that the assembly surface 471a faces the relative connector 490 through turning (a direction of arrow \textcircled{1}). In addition, the relative connector 490 may be assembled to the door connector 470 (a direction of arrow \textcircled{1}). FIG. 9 illustrates the movement supporter 450 and the door connector 470 disposed in the operation position.

For convenience of description, describing the door connector 470 of the connector module 400 with reference to FIG. 11, the door connector 470 can have roughly a hexahedral structure. The door connector 470 can include a connector body 471 of an insulator in which a plurality of terminals can be disposed. Terminal wires can be connected to the terminals. The terminal wires can constitute the door wire W2. FIG. 11 illustrates terminal holes 472 into which the terminals are inserted.

An assembly surface 471a can be provided on a front surface of the door connector 470. The assembly surface 471a can be a surface facing the connector inlet 73a. The assembly surface 471a can be a portion assembled with the relative connector 490.

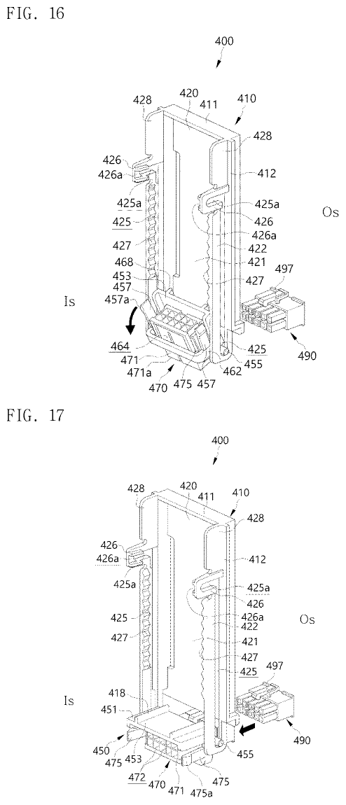

While the assembly surface 471a faces the operation position, the door connector 470 may be linearly moved along the movement supporter 450. The door connector 470 moved to the operation position may be turned with the movement supporter 450 so that the assembly surface 471a may face the relative connector 490. This figure as described above is illustrated in FIG. 17.

A structure can be disposed on the surface of the door connector 470 to fix the door connector 470 to the movement supporter 450. Specifically, a connector lance part 475 can protrude on a surface of the door connector 470. The connector lance part 475 can pass through a mounting hole 464 provided in the movement supporter 450 and can be fixed by being caught by the opposite side of the mounting hole 464. Then, the door connector 470 is prevented from being separated in the opposite direction, i.e., an upward direction based on FIG. 9.

The connector module 400 can include the mounting base 410. The mounting base 410 can be fixed to the connector storage portion CM. The mounting base 410 can guide the movement of the movement supporter 450 and the movement of the door connector 470.

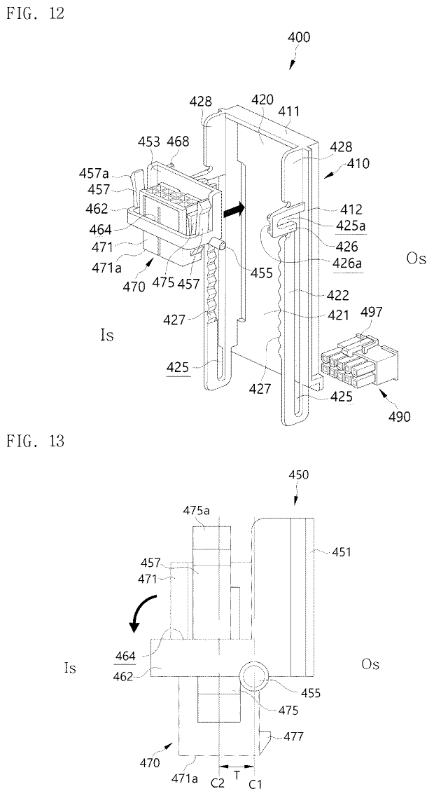

Since the mounting base 410 can be fixed, the mounting base 410 can be moved relatively to the movement supporter 450 and the door connector 470. FIG. 14 illustrates the door connector 470 disposed at the storage position.

The mounting base 410 can guide the movement of the movement supporter 450 and the movement of the door connector 470. The mounting base 410 can be fixed to the connector storage portion CM, thereby preventing the movement supporter 450 and the door connector 470 from also being separated from the connector storage portion CM. The mounting base 410 can guide an extension direction of the door wire W2 as described below.

Describing the mounting direction of the mounting base 410, as illustrated in FIG. 12, a rear surface of the mounting base 410 can face the front space of the lower door 70. When viewed from the front space of the lower door 70, the movement supporter 450 and the door connector 470 disposed on the front surface of the mounting base 410 can be covered by the mounting base 410. Of course, since the connector module 400 including the mounting base 410 can be disposed outside the window V, the connector module 400 can be covered by an edge portion of the lower door 70.

In some examples, the mounting base 410 can cross a portion of the window V, but a lower surface of the mounting base 410 has a flat surface structure, and the mounting base 410 can cover both the door connector 470 and the movement supporter 450, so the mounting base 410 can be partially exposed to external space (front space of the lower door 70).

A vertical height (Z-axial direction in FIG. 1) of the mounting base 410 in a movement direction of the movement supporter 450 may be formed wider than a transverse width in the transverse direction (Y-axial direction in FIG. 1) perpendicular to the vertical height. The transverse width of the mounting base 410 may be formed smaller than or equal to the width of the installation region T1 to T4. Accordingly, the mounting base 410 may not be separated from the installation region T1 to T4.

The mounting base 410 does not completely cover the movement supporter 450 and the door connector 470, but may expose the movement supporter 450 and the door connector 470. However, the connector module 400 is disposed in the connector storage part CM provided in the door, thereby preventing the connector module 400 from being visible from the outside space.

The door wire W2 may extend upward of the mounting base 410. The main wire W1 may extend downward of the mounting base 410.

In FIG. 9, the door connector 470 and the relative connector 490 have been moved to the operation position. In the operation position, the door connector 470 may be assembled to or separated from the relative connector 490. When the door connector 470 and the relative connector 490 are turned in one direction (direction of arrow \textcircled{2}) from the state in FIG. 9 and then pushed upward (direction of arrow \textcircled{1}), the door connector 470 and the movement supporter 450 may be moved together with the relative connector 490.

In addition, the door connector 470, the relative connector 490, and the movement supporter 450 may be moved to the storage position.

Herein, the door connector 470 may be moved in a constant section with the movement supporter 450. As described below, a storage fixation part 427, 457 may fix the movement supporter 450 and the connector assembly C to a plurality of storage positions.

As illustrated in FIG. 7, a part of the door connector 470 disposed in the operation position may protrude outside of the connector inlet 73a. The sum of the length of the part of the door connector 470 protruding outward of the connector inlet 73a and the length of the relative connector 490 may be shorter than or equal to a linear movement range of the door connector 470. Then, when the connector assembly C is moved to the storage position, the relative connector 490 is also moved to the storage position to prevent the entire connector assembly C from being exposed outward. In other words, when the connector assembly C is moved to the storage position, the relative connector 490 is also moved to the storage position so that the entire connector assembly C may be disposed higher than the lower end of the mounting base 410. Referring to FIG. 14, a lower end of the relative connector 490 is disposed on a seating surface 421 of the mounting station 420 and may be prevented from protruding downward.

The structure of the mounting base 410 will be described in detail with reference to FIG. 9. A frame of the mounting base 410 may be formed of abase body 411 of a flat plate structure. The mounting station 420 may be disposed on a first surface of the base body 411. A second surface of the base body 411 may be brought into close contact with the surface of the front panel Ga. For example, the second surface of the base body 411 may adhere to the surface of the front panel Ga as a fixation surface. As another example, the base body 411 may be fixed to the door frame 72, 77, 80, 90, not a surface of the front panel Ga.

A guide fence 412 may be provided at either side of the base body 411. The guide fence 412 may be stood outside the mounting station 420. The guide fence 412 may be provided in a movement direction of the door connector 470 outside the mounting station 420. In the embodiment, the guide fence 412 is provided at either side of the mounting station 420. As another example, the guide fence 412 may be provided on either side of the mounting station 420 or may be omitted.

Although not shown in the drawings, the base body 411 may include a wire guide. The wire guide may guide a direction in which the door wire W2 extends. The wire guide may protrude from the base body 411. The wire guide may be disposed between the image acquisition module 100 and the door connector 470. The wire guide covers the door wire W2 to enable the door wire W2 to extend in a preset direction.

Referring to FIG. 9, the mounting base 410 may include the mounting station 420. The mounting station 420 may be provided on the mounting base 410 in the movement direction of the movement supporter 450. A surface of the mounting station 420 may be a flat surface structure.

The seating surface 421 may be formed on a surface of the mounting station 420. The seating surface 421 may be a flat surface on which the movement supporter 450 slides on the mounting station 420. Since the mounting station 420 is a portion protruding from the base body 411, the seating surface 421 may also be formed higher than other portions of the base body 411.

A fixation rail 422 can be provided at either side portion of the mounting station 420. The fixation rail 422 can stand on either side of the mounting station 420 in a parallel direction. The fixation rail 422 can have roughly a unidirectionally long rod structure. The fixation rail 422 can extend from the storage position of the movement supporter 450 to the operation position.

The fixation rail 422 can be spaced apart from the mounting station 420. A guide slot 425 can be open at a spacing between the fixation rail 422 and the mounting station 420. The guide slot 425 can be a hole continuously formed in a longitudinal direction of the fixation rail 422. A supporter shaft 455 of the movement supporter 450 can be inserted into the guide slot 425.

Herein, the guide slot 425 can protrude from one end of the mounting station 420 outward of the mounting station 420. Referring to FIG. 11, the guide slot 425 can protrude lower than the lower end of the mounting station 420, i.e., further protrude in the movement direction of the movement supporter 450. Accordingly, the movement supporter 450 can be moved to a position deviating from the mounting station 420. As described above, at the position where the movement supporter 450 deviates from the mounting station 420, the movement supporter 450 does not interfere with the mounting station 420 and can be turned.

A terminal end of the guide slot 425 can be a turning part (not assigned with reference numeral). As illustrated in FIG. 62, the movement supporter 450 moved to the terminal end of the guide slot 425 can change into a turnable state. Specifically, the turning part can have a curved structure corresponding to a surface of the supporter shaft 455. Accordingly, the supporter shaft 455 can be turned while being in surface contact with the turning part.

The guide slot 425 can include the slot entrance 425a. The slot entrance 425a can be a portion further extending in a different direction from the extending direction of the guide slot 425. For example, the slot entrance 425a can be provided in a first direction (an arrow direction of FIG. 12). The guide slot 425 can be provided in a second direction different from the first direction (an arrow direction \textcircled{1} of FIG. 9). The guide slot 425 and the slot entrance 425a can form roughly an “L” shape. The slot entrance 425a can be connected to an insertion guide 426 described below, thereby forming an entrance into which the supporter shaft 455 is inserted.

The fixation rail 422 can include the first position fixation portion 427. The first position fixation portion 427 can constitute the storage fixation portion 427, 457 with the second position fixation portion 457 of the movement supporter 450 described below. The storage fixation portion 427, 457 can fix the movement supporter 450 and the connector assembly C to the storage position. When the movement supporter 450 and the connector assembly C are fixed to the storage position by the storage fixation portion 427, 457, the movement supporter 450 and the connector assembly C are not returned to the operation position, and remain fixed to the connector storage portion CM.

The storage fixation portion 427, 457 can be disposed in the movement direction of the door connector 470 continuously or discontinuously. When the storage fixation portion 427, 457 is provided in the movement direction of the door connector 470 continuously, the movement supporter 450 and the connector assembly C can be fixed to a plurality of storage positions in phases. When the storage fixation portion 427, 457 is discontinuously provided in the movement direction of the door connector 470, the movement supporter 450 and the connector assembly C can be fixed to a limited storage position.

The storage fixation portion 427, 457 can include the first position fixation portion 427 and the second position fixation portion 457. The first position fixation portion 427 can be provided on the fixation rail 422 of the connector module 400. The second position fixation portion 457 can be provided in the movement supporter 450 or the door connector 470. The second position fixation portion 457 can be engaged with the first position fixation portion 427. When the second position fixation portion 457 is engaged with the first position fixation portion 427, the second position fixation portion 457 can remain caught by and fixed to the first position fixation portion 427.

Referring to FIG. 9, the first position fixation portion 427 can be continuously provided along the surface of the fixation rail 422. The first position fixation portion 427 can have an uneven structure. The first position fixation portion 427 can include a pair of first position fixation portions 427 facing each other. The pair of first position fixation portions 427 can face each other. Accordingly, each first position fixation portion 427 can be configured by repeatedly arranging the structure protruding toward the first position fixation portion 427 at the opposite side and the structure recessed in the opposite direction. For example, the first position fixation portion 427 can have a sawtooth structure.

In some examples, the guide slot 425 can be provided along the movement direction of the movement supporter 450 to be relatively longer than the first position fixation portion 427. When the guide slot 425 is longer than the first position fixation portion 427, the movement supporter 450 can be moved to a position deviating from the first position fixation portion 427. The movement supporter 450 may not be fixed to the first position fixation portion 427 at a position deviating from the first position fixation portion 427, i.e., at the operation position, and can be freely turned.

The insertion guide 426 can be provided at one end of the fixation rail 422. The insertion guide 426 can be provided at one end portion of the fixation rail 422 close to the storage position. The insertion guide 426 can form an entrance through which the supporter shaft 455 of the movement supporter 450 is inserted into the guide slot 425. The insertion guide 426 can protrude from the mounting station 420 with a cantilever structure. The insertion guide 426 can include a pair of guide ribs 426b, and an insertion channel 426a can be formed between the pair of guide ribs. The slot entrance 425a of the guide slot 425 can be connected to an inside part of the insertion channel 426a.

The mounting base 410 can include a side surface fence 428. The side surface fence 428 can stand on either end of the mounting base 410. The side surface fence 428 can be formed higher than the fixation rail 422. The side surface fence 428 can guide either side surface of the movement supporter 450 when the movement supporter 450 is inserted into the mounting base 410.

Next, a frame of the movement supporter 450 may be formed by a supporter body 451. The supporter body 451 may have a flat plate structure. A first surface of the supporter body 451 may be the supporting board 453 on which the door connector 470 is seated. A second surface of the supporter body 451 may be brought into close contact with the seating surface 421 of the mounting base 410. The entire length of the supporter body 451 (a vertical length based on the drawing) may be shorter than or equal to the length of the mounting station 420.

Referring to FIG. 11, the supporter body 451 may include a supporting fence 452. The supporter fence 452 may protrude while surrounding an edge of the supporter body 451. The supporter fence 452 may form a connector mounting space on the first surface of the supporter body 451.

The supporter body 451 may include a supporting board 453. The supporting board 453 may be disposed in a central portion of the first surface of the supporter body 451. The door connector 470 may be seated on the supporting board 453. In the mounting process of the door connector 470, the door connector 470 may be assembled to a connector holder 462 while sliding on the supporting board 453.

The supporter body 451 of the movement supporter 450 can include the supporter shaft 455. The supporter shaft 455 can be provided at either side surface of the supporter body 451. The supporter shaft 455 can have a cylindrical shape. The supporter shaft 455 can be a turning shaft enabling the movement supporter 450 to be moved between the storage position and the operation position and the movement supporter 450 to be turned at the same time. FIG. 9 illustrates that the supporter shaft 455 can be moved to the lowermost end of the guide slot 425 and then the movement supporter 450 can be turned on the supporter shaft 455.

The supporter body 451 can include the second position fixation portion 457. The second position fixation portion 457 can be engaged with the first position fixation portion 427. The second position fixation portion 457 can extend with a cantilever shape from the supporter body 451. The second position fixation portion 457 can be a cantilever shape in which a first end portion is a fixation end fixed on the surface of the supporter body 451 and a second end portion is a free end. Accordingly, the second position fixation portion 457 can be elastically deformed in the interference process with the first position fixation portion 427. In some examples, the second position fixation portion 457 can be provided into a cantilever shape on either side surface of the supporter body 451.

One end of the second position fixation portion 457 can include a fixation end portion 457a. The fixation end portion 457a can be a portion relatively thicker than other portions in the second position fixation portion 457. The fixation end portion 457a can be fixed by being caught by the first position fixation portion 427 of the uneven shape. The fixation end portion 457a can have a shape engaged with the gear shape structure of the first position fixation portion 427.

In the embodiment, the second position fixation part 457 has an elastic deformable structure. Therefore, the second position fixation part 457 may be elastically deformed in the process in which the second position fixation part 457 is engaged with the first position fixation part 427. As another example, the first position fixation part 427 may have an elastic deformable structure. The first position fixation part 427 has a cantilever structure, and the movement supporter 450 may be moved with the second position fixation part 457 elastically deforming the first position fixation part 427.

As another example, the storage fixation part 427, 457 may have a structure in which the movement supporter 450 is press-fitted into the mounting base 410, not the elastic deformation structure. As another example, the movement supporter 450 may be assembled to the storage fixation part 427, 457 to be turned, or have a latch structure. Otherwise, the movement supporter 450 may be fixed to the mounting base 410 through a separate fastener.

Referring to FIG. 11, the supporter body 451 can include the supporting board 453. The connector holder 462 can be provided on a lower end of the supporting board 453. The connector holder 462 can fix the door connector 470 to the movement supporter 450. The connector holder 462 can have roughly a kind of rectangular frame structure surrounding a surface of the door connector 470. The mounting hole 464 is provided in a central portion of the connector holder 462, and the door connector 470 can be disposed in the mounting hole 464.

The connector holder 462 can include the connector support end 463. The connector support end 463 can form the mounting hole 464 with the connector holder 462. When the connector holder 462 surrounds the first surface and both side surfaces of the door connector 470, the connector support end 463 can support the second surface of the door connector 470.

The supporter foot 468 can be provided on the lower surface of the movement supporter 450. The supporter foot 468 can protrude a lower surface of the movement supporter 450 facing the surface of the mounting base 410. The supporter foot 468 can have an elongated structure extending long in a longitudinal direction of the movement supporter 450, i.e., the movement direction of the movement supporter 450. Reference to FIG. 68, the supporter foot 468 can reduce a contact area between the movement supporter 450 and the mounting station 420, thereby reducing a friction force when the movement supporter 450 is moved.

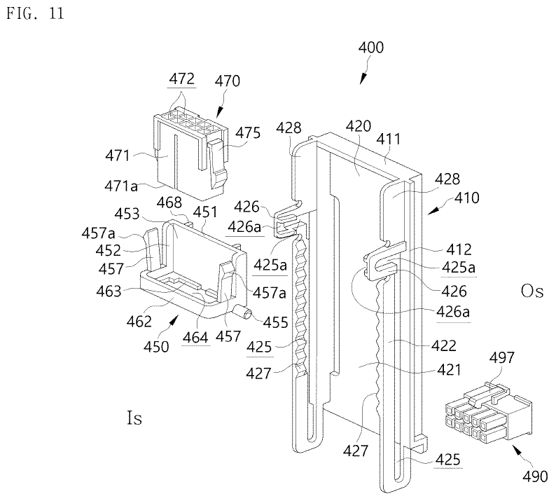

FIG. 13 illustrates a side structure of the assembly of the door connector 470 and the movement supporter 450. Herein, an imaginary vertical line passing through the supporter shaft 455 may be expressed as C1, and an imaginary vertical line passing through the center of gravity of the assembly of the door connector 470 and the movement supporter 450 may be expressed as C2. Herein, the imaginary vertical line passing through the supporter shaft 455 and the imaginary vertical line passing through the center of gravity of the assembly may extend in parallel to each other. The imaginary vertical line passing through the supporter shaft 455 and the imaginary vertical line passing through the center of gravity of the assembly may be spaced apart from each other by a predetermined distance T. In other words, the center of gravity of the assembly of the door connector 470 and the movement supporter 450 may be disposed on a position eccentric from the supporter shaft 455.

Preferably, the center of gravity of the assembly of the door connector 470 and the movement supporter 450 may be disposed at a position further away from the mounting station 420 than the supporter shaft 455. Then, the assembly of the door connector 470 and the movement supporter 450 may be turned in one direction (an arrow direction of FIG. 13) on the supporter shaft 455 as a turning center. Therefore, the assembly of the door connector 470 moved to the operation position and the movement supporter 450 may be automatically turned and the assembly surface 471a may face the relative connector 490.

FIGS. 14 to 17 sequentially illustrate a process in which the door connector 470 is assembled with the relative connector 490 after the door connector 470 is moved from the storage position to the operation position. Referring to FIG. 14, the assembly of the door connector 470 and the movement supporter 450 may be disposed at the storage position.

In this state, after the fabricator accesses the movement supporter 450 through the connector inlet 73a (referring to FIG. 18), the fabricator can pull the movement supporter 450. The arrow of FIG. 14 indicates a direction in which the fabricator pulls the movement supporter 450. Of course, the fabricator can directly pull the door connector 470, not the movement supporter 450.

The movement supporter 450 can be linearly moved along the mounting station 420. In the movement process, the second position fixation part 457 may continuously pass the first position fixation part 427. Herein, the second position fixation part 457 is engaged with the continuous uneven part of the first position fixation part 427, thereby repeating elastic deformation and recovery of an original form.

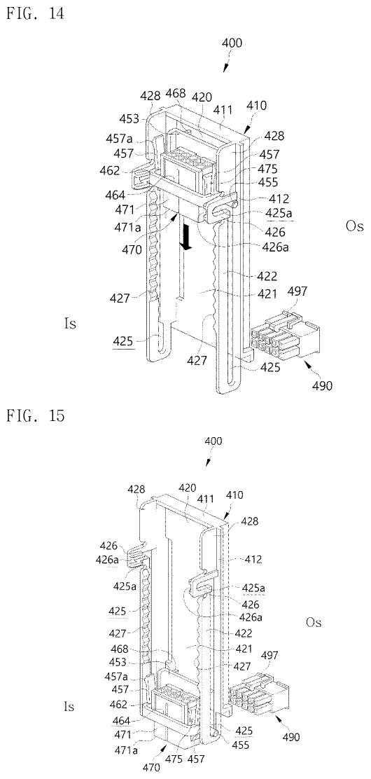

FIG. 15 illustrates the assembly of the door connector 470 and the movement supporter 450 moved to the operation position. Herein, the assembly surface 471a of the door connector 470 faces the lower space. In other words, the door connector 470 may maintain a constant direction in the linear movement process.

The assembly of the door connector 470 and the movement supporter 450 which are moved to the operation position may be turned. The assembly of the door connector 470 and the movement supporter 450 may be turned on the supporter shaft 455 by gravity. FIG. 16 illustrates a middle state in which the assembly of the door connector 470 and the movement supporter 450 are turned. As described above, the center of gravity of the assembly of the door connector 470 and the movement supporter 450 is eccentric from the supporter shaft 455, so the assembly of the door connector 470 and the movement supporter 450 may be automatically turned by gravity.

FIG. 17 illustrates that the assembly of the door connector 470 and the movement supporter 450 is turned at 90 degrees and the assembly surface 471a faces the relative connector 490. In this state, when the relative connector 490 is moved in a direction toward the door connector 470 (arrow direction in FIG. 17), the relative connector 490 may be assembled from the assembly surface 471a of the door connector 470. An assembly hook 497 of the relative connector 490 may catch the door connector 470, two connectors may be assembled with each other.

FIGS. 18 and 19 illustrate the connector module 400 mounted to the connector storage part CM in the lower door 70. As illustrated in the drawing, the connector inlet 73a is open in the lower portion of the lower door 70, and the connector inlet 73a may include the operation space F, i.e., an empty space. The operation space F may be a clearance into which the fabricator can put a finger. Although the door connector 470 is disposed at the storage position, the fabricator can access the door connector 470 through the operation space F.

As illustrated in FIG. 18, the door connector 470 and the movement supporter 450 can be disposed at the storage position, so that outward exposure thereof cannot be exposed. Specifically, since the connector module 400 is disposed at a position deviating from the window V or only at least a part of the connector module 400 crosses the window V, the outward portion of the connector module 400 may be less. The connector module 400 is disposed adjacent to the connector inlet 73a, so that the fabricator can easily operate.

FIG. 19 illustrates the movement supporter 450 and the door connector 470 are turned after the movement supporter 450 and the door connector 470 are moved to the operation position. When the door connector 470 is turned, the door connector 470 faces in a direction in which the door connector 470 is assembled with the relative connector 490. In this state, the fabricator can assemble the relative connector 490 to the door connector 470 in front of the lower end of the lower door 70, or separate the relative connector 490. Therefore, the fabricator does not need to align the two connectors to assemble the two connectors. Furthermore, since the door connector 470 is supported in a direction toward the relative connector 490, the two connectors may be efficiently performed.

Meanwhile, as illustrated in FIG. 19, the connector inlet 73a may include a mounting cover 480. The mounting cover 480 may block the connector inlet 73a, so that the connector assembly C may be covered. More specifically, the mounting cover 480 may allow passing of the main wire W1 extending from the relative connector 490, and cover the lower portion of the relative connector 490. When the mounting cover 480 is moved in FIG. 19, a lower part of the relative connector 490 may be exposed.

Although not shown in the drawings, the connector storage part CM can be provided in the front frame part 72 constituting a frame of the door body. Referring to FIG. 7, the front side plates 7a, i.e., a part of the front frame part 72, may constitute both side surfaces of the door body. As described above, the connector storage part CM may be provided in a front side plate 72a constituting both side surfaces of the door body.

The connector module 400 can stand in the connector storage part CM. The connector module 400 is not seated on the front panel Ga, and may be disposed in the connector storage part CM provided in the front side plate 72a. A transverse width of the connector module 400 may be formed equal to or smaller than the width of each front side plate 72a. Since the connector storage part CM is provided at the lower end of the front frame part 72, the fabricator can easily access the connector module 400 through the connector inlet 73a of the lower door 70.

Herein, each front side plate 72a has roughly a concavely “c” shape, and the connector storage portion CM can be provided in the concave portion. The connector storage portion CM can be integrally formed with the front side plate 72a. Accordingly, the door connector 770 can be linearly moved along the concave portion of the front side plate 72a.

Although not shown in the drawing, the movement supporter 450 can be moved transversely with respect to the mounting base 710. Based on FIG. 7, the movement supporter 450 may be moved in the transverse direction, i.e., the width direction of the lower door 70, not the vertical direction.

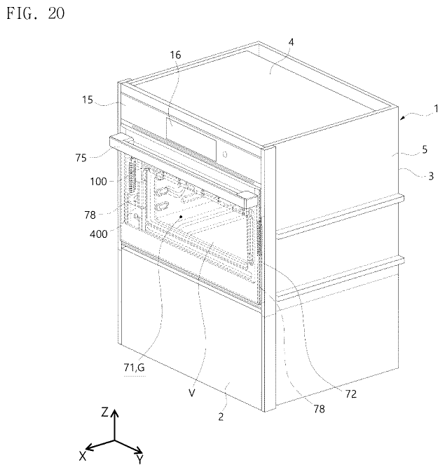

FIG. 20 illustrates another example of a home appliance according to the present disclosure. As illustrated in the drawing, the home appliance can be a built-in type of home appliance. For example, the home appliance may be a cooking appliance installed in a built-in manner. As illustrated in the drawing, the cooking appliance of the embodiment may be installed in kitchen furniture 1, etc., and the front surface of the cooking appliance may only be exposed forward. A lower part, a rear surface 3, an upper surface 4, and a side surface 5 of the kitchen furniture 1 may shield portions of the home appliance excluding the operating part 15, the display 16, the door 70, etc. that are disposed at the front surface of the home appliance. The image acquisition module 100 and the connector module 400 may be disposed in the lower door 70.

In the embodiment, the window may be omitted in the door 70. The inside space of the home appliance is not visible through the door 70 and may be checked only through the image acquisition module 100. There is no risk that the image acquisition module 100 may be exposed forward of the home appliance through the window, so the image acquisition module 100 may be disposed in a central region inside the door 70.

Although the preferred implementations of the present disclosure have been described for illustrative purposes, those skilled in the art will appreciate that various modifications, additions and substitutions are possible, without departing from the scope and spirit of the present disclosure as disclosed in the accompanying claims. Therefore, the preferred implementations described above have been described for illustrative purposes, and should not be intended to limit the technical spirit of the present disclosure, and the scope and spirit of the present disclosure are not limited to the implementations. The protective scope of the present disclosure should be interpreted by the accompanying claims, and all technical spirits within the equivalent scope should be interpreted as being included in the scope and spirit of the present disclosure.

What is claimed is:

1. A door for an appliance, the door comprising:
a door body configured to be disposed at a front of a storage space of the appliance, the door body accommodating an electronic component therein; and
a connector module disposed in the door body and electrically connected to the electronic component through a door wire,
wherein the connector module comprises:
a mounting base disposed inside the door body, and
a movement supporter disposed at the mounting base and configured to couple to a door connector, and
wherein the movement supporter is configured to:
linearly move between a storage position and an operation position along the mounting base, and
turn relative to the mounting base based on the movement supporter being disposed at the operation position.

2. The door of claim 1, wherein the mounting base defines a guide slot that extends in a movement direction of the movement supporter, and
wherein the movement supporter comprises a supporter shaft that is inserted in the guide slot.

3. The door of claim 2, wherein the mounting base comprises a fixation rail that is parallel to the guide slot, the fixation rail comprising a storage fixation part configured to restrict the movement supporter from moving from the storage position, and
wherein the storage fixation part comprises a surface of the movement supporter that faces the fixation rail and is configured to restrict movement of the movement supporter relative to the mounting base.

4. The door of claim 3, wherein the mounting base comprises a mounting station,
wherein the movement supporter is configured to move along the mounting station, and
wherein the guide slot is defined between the mounting station and the fixation rail.

5. The door of claim 4, wherein the guide slot extends further from a first end of the mounting station to an outside of the mounting station, and
wherein the operation position is defined at the outside of the mounting station.

6. The door of claim 2, wherein the guide slot is defined at one or both sides of the mounting base, and
wherein the supporter shaft is disposed at one or both side surfaces of the movement supporter.

7. The door of claim 3, wherein the storage fixation part comprises:
a first position fixation part disposed at the fixation rail; and
a second position fixation part disposed at the surface of the movement supporter and engaged with the first position fixation part.

8. The door of claim 7, wherein the first position fixation part includes an uneven structure arranged disposed along the movement direction of the movement supporter, and
wherein the second position fixation part is configured to elastically deform and be caught and fixed by the first position fixation part.

9. The door of claim 7, wherein the guide slot is longer than the first position fixation part in the movement direction of the movement supporter.

10. The door of claim 2, wherein the guide slot defines a turning part at a distal end of the guide slot, the turning part having a curved surface corresponding to a surface of the supporter shaft, and
wherein the movement supporter is configured to turn at the turning part of the guide slot relative to the mounting base.

11. The door of claim 2, wherein the supporter shaft is disposed at an eccentric position with respect to a center of gravity of the movement supporter coupled to the door connector.

12. The door of claim 2, wherein a center of gravity of the movement supporter coupled to the door connector is disposed farther from a front surface of the door body than from the supporter shaft.

13. The door of claim 1, wherein the door connector comprises an assembly surface configured to be exposed to a front side of the door body based on the door connector turning relative to the mounting base at the operation position.

14. The door of claim 2, wherein the guide slot defines a slot entrance at a first end thereof, and
wherein the supporter shaft of the movement supporter is inserted into the guide slot through the slot entrance.

15. The door of claim 14, wherein the slot entrance extends in a first direction, and the guide slot extends in a second direction different from the first direction.

16. The door of claim 14, wherein the connector module further comprises an insertion guide that protrudes from the mounting base in a first direction, the insertion guide defining the slot entrance.

17. The door of claim 16, wherein the insertion guide defines an insertion channel that extends in the first direction and is connected to the slot entrance.

18. The door of claim 1, wherein the movement supporter comprises a supporter foot that protrudes from a surface of the movement supporter toward the mounting base, the supporter foot being configured to, based on the movement supporter moving along the mounting base, come into contact with the mounting base.

19. The door of claim 1, further comprising a door panel that is disposed at a center portion of the door body, the door panel comprising a window through which the storage space is visible,
wherein the door body and the door panel define an indoor space in the door, the indoor space including an installation region that is disposed around an outer portion of the window, and
wherein the connector module is disposed at the installation region.

20. An appliance comprising:
a main body that defines a storage space therein;
a door body that is disposed at a front of the storage space and accommodates an electronic component therein; and
a connector module disposed in the door body and electrically connected to the electronic component through a door wire,
wherein the connector module comprises:
a mounting base disposed inside the door body, and
a movement supporter disposed at the mounting base and configured to couple to a door connector, and
wherein the movement supporter is configured to:
linearly move between a storage position and an operation position along the mounting base, and
turn relative to the mounting base based on the movement supporter being disposed at the operation position.
